(19) United States
(12) Patent Application Publication
(10) Pub. No.: US 2005/0217166 A1
(43) Pub. Date: Oct. 6, 2005

(54) Live-bait-simulating, resilient puppet fishing lure

(76) Inventor: Joel Vincent MacDonald, Salt Lake City, UT (US)

Correspondence Address: Angus C. Fox, III, 4093 N. Imperial Way, Provo, UT, 84604-5386, US

(21) Appl. No.: 11/093,439

(22) Filed: Mar. 30, 2005

Related U.S. Application Data
(60) Provisional application No. 60/557,744, filed on Mar. 30, 2004.

(51) Int. Cl. A01K 85/00

(52) U.S. Cl. 43/42.36; 43/42.24

(57) ABSTRACT

A bendable resilient fishing lure, that simulates the movement of live bait when a fisherman tugs on the fishing line, includes a resilient body molded to appear like a small animal such as an earthworm or small fish, the body having a fishing line securing device, at least one aperture in the body spaced apart from the securing device through which the fishing line is threaded, a resistance device slidably mounted on the fishing line between the fisherman and the body. When the fisherman tugs the fishing line, the resistance device applies a force to the body, causing it to bend. When the tugging stops, the resilient body returns to its original shape. The resistance device may be either a weight or a disk. The disk may include a tubular spacer so that the disk is spaced away from the body.₍₁₄₀₎

This application has a priority date of Mar. 30, 2004, as evidenced by the filing on that date of a Provisional Patent Application Ser. No. 60/557,744 titled MOVABLE RUBBER WORM FISHING LURE.

### BACKGROUND OF THE INVENTION

1. Field of the Invention

This invention relates to fishing lures and, more particularly, to fishing lures which can be made to move to simulate the movements of live bait.

2. Description of the Prior Art

Probably no class of patents is more symptomatic of the American obsession with leisure activities than that of fishing lures. For many decades, inventors have attempted to imbue lifeless lures with characteristics of live bait.

U.S. Pat. No. 2,910,799 to Wentworth discloses an articulated fishing lure having a body with a fore portion and an aft portion interconnected by a leaf spring. A fishing line passing through an aperture in the fore portion is tied to an eye screw on the aft portion. A concave plate rigidly attached to the fore portion provides water resistance so that the leaf spring temporarily bends when the lure is pulled through the water.

U.S. Pat. No. 3,376,663 to Amrine discloses a fishing lure having a main body portion and apendages formed integrally from resiliently flexible material and having a covered spring steel wire frame embedded therein. A guide tube extends longitudinally through the main body and a line extends through the guide and is connected at one end to the frame at points on the appendages spaced from the main body for remotely controlling the flexing of the appendages. A pull or sharp tug on the line will result in flexing of the leg appendages as the inertia of the lure and its resistance to movement through the water oppose the force produced by a pull on the line.

U.S. Pat. No. 4,208,822 to Bryant discloses a lure designed to simulate the movements and sounds of a squid as it advances through the water. The Bryant lure includes a massive head and at least one collapsible intermediate body portion connected to an elongate wire. During use, pulling on the fishing line causes the tail end of the lure to move toward the head and collapse the intermediate body portion before the head moves forward through the water. The collapsing intermediate body portion also generates an audible sound which is much like the sound made by a squid.

U.S. Pat. No. 5,829,183 to Guerin discloses an artificial bait which simulates a wounded or dying natural prey of game fish. The bait includes an upper lure body section having a weighted bill, an interior channel for receiving a fishing line and a vertical channel for retaining a hook support wire, a lower tail section having a tail actuator mechanism, and a hinge mechanism. The tail actuator mechanism includes an actuator wire having a tying eye at each end and a counterweight in the proximity of one end. Operation of the invention causes the bill to dip and rise in the water as the tail moves between a horizontal and vertical position, and the lure stays suspended without moving forward. Cranking the bait forward causes the body of the lure to wobble through the water, similar to an injured fish, unable to right itself.

All of the patents heretofore referenced disclose fishing lures that are large, relatively expensive and complex structures. What is needed is are compact, inexpensive fishing lures that simulate the movements of live bait

### SUMMARY OF THE INVENTION

A bendable resilient fishing lure simulates the movement of live bait when a fisherman tugs on the fishing line. It includes a resilient body molded to appear like a small animal such as an earthworm or small fish. The body is equipped with an attached hook, a fishing line securing device, which may be an aperture in the body or a small loop or eyelet embedded in the body, at least one aperture in the body spaced apart from the securing device and generally perpendicular to the longitudinal axis of the body, through which the fishing line is threaded en route to the anchoring device, and a resistance device slidably mounted on the fishing line between the fisherman and the body. For a preferred embodiment of the invention, the securing device is an aperture, and the hook is secured to the end of the fishing line, with a bead placed between the securing aperture and the hook, so that the hook will both stand out from the body and not be pulled through the securing aperture. Eyelets may be molded in the body to form the apertures. The eyelets may be polished metal or a hard plastic having a low coefficient of friction, such as nylon, Teflon®, or high-density polyethylene. When the fisherman tugs the fishing line, the resistance device applies a force to the body, causing it to bend. When the tugging stops, the resilient body returns to its original shape. The resistance device may be either a weight or a disk. As the disk is pulled through the water, it slides against the resilient body causing it to bend. The larger the disk, the greater the force applied against the resilient body. A tubular extension that is coaxial with the disk helps maintain the disk perpendicular to the direction of movement through the water and, if oriented so the tubular extension faces the resilient body, also spaces the disk away from the body. If a lead or other metal weight is slidably mounted in place of the disk, the inertia of the weight permits the body to bend as the fishing line is tugged. A slidable disk is the presently preferred resistance device, as it need not be more dense than water, thereby permitting the manufacture of lures of varying densities: lures that float, lures that have the same density as water, and lures that sink to the bottom after casting. The added density of the lure caused by the addition of a sliding weight may be at least partially overcome by incorporating at least one air-filled bladder in the resilient body. The resilient body may be made from molded rubber

### BRIEF DESCRIPTION OF THE DRAWINGS

FIG. 1 is a grommet-side elevational view of a resilient worm movable fishing lure;

FIG. 2 is a cross-sectional view of a first embodiment resilient worm movable fishing lure, taken through section line 2-2 of FIG. 1;

FIG. 3 is a cross-sectional view of a second embodiment resilient worm movable fishing, taken through section line 2-2 of FIG. 1;

FIG. 4 is the cross-sectional view of FIG. 2, showing the routing of a fishing line through a first resistance device, the five grommets of the lure, and the eye of a hook;

FIG. 5 is an elevational view of the assembly of FIG. 4;

FIG. 6 is the cross-sectional view of FIG. 2, showing the routing of a fishing line through a second resistance device, the five grommets of the lure, and the eye of a hook;

FIG. 7 is an elevational view of the assembly of FIG. 6;

FIG. 8 is an elevational view of the assembly of FIG. 5, following a tug on the fishing line;

FIG. 9 is an elevational view of the assembly of FIG. 7, following a tug on the fishing line;

FIG. 10 is a left-side elevational view of a second embodiment resilient minnow movable fishing lure;

FIG. 11 is a top plan view of the second embodiment resilient minnow movable fishing lure of FIG. 10, a hook and a first resistance device, showing the routing of a fishing line therethrough;

FIG. 12 is a top plan view of the second embodiment resilient minnow movable fishing lure of FIG. 10, a hook and a second resistance device, showing the routing of a fishing line therethrough;

FIG. 13 is a top plan view of the assembly of FIG. 11, following a tug on the fishing line;

FIG. 14 is a top plan view of the assembly of FIG. 12, following a tug on the fishing line; and

FIG. 15 is an isometric view of a first resistance device.

### DETAILED DESCRIPTION OF THE INVENTION

The present invention provides a bendable resilient fishing lure, which simulates the movement of live bait when a fisherman tugs on the fishing line. It includes a resilient body molded to appear like a small animal such as an earthworm or small fish. The body is equipped with an attached hook, a fishing line securing device, at least one aperture in the body spaced apart from the securing device and generally perpendicular to the longitudinal axis of the body, through which the fishing line is threaded en route to the anchoring device, and a resistance device slidably mounted on the fishing line between the fisherman and the body. The invention will now be described in detail with reference to the attached drawing figures.

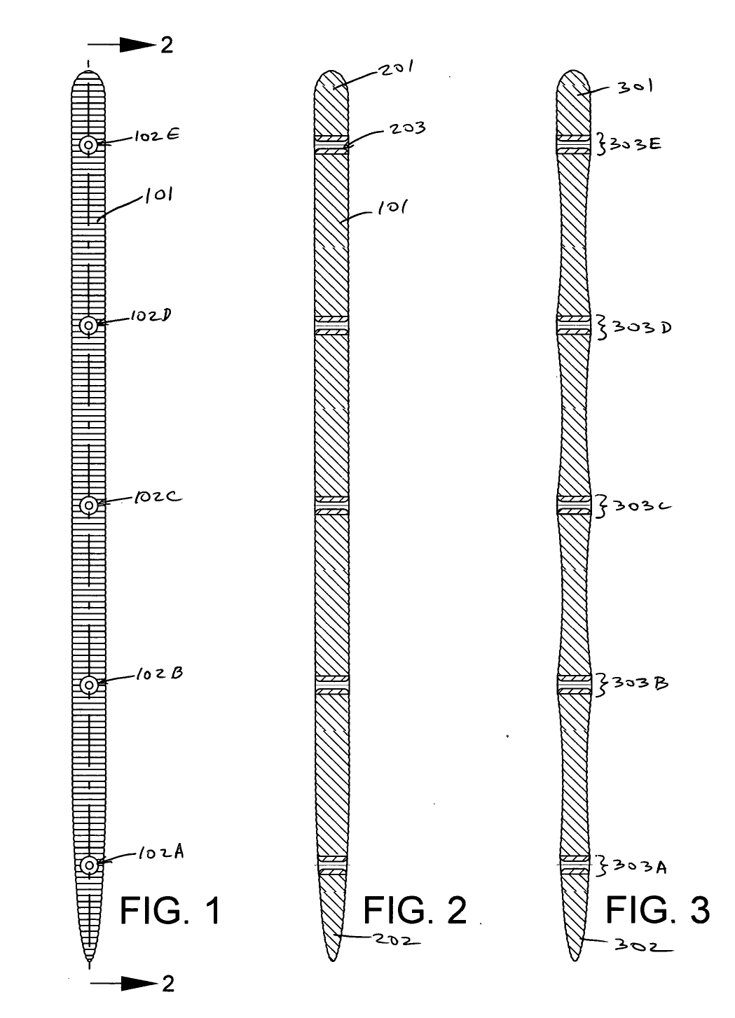

Referring now to FIG. 1, a first general embodiment of the bendable resilient fishing lure has a resilient body 101 molded in the shape of an annelid worm. The body may be molded from one of many available elastomeric compounds. An elastomeric compound is a polymeric rubber-like material that at room temperature returns rapidly to approximately to its initial dimensions and shape after being substantially deformed by a weak stress, when the stress is released. Both natural and synthetic rubber compounds are suitable eslastomeric materials. Such materials specifically include RTV and HTV silicone rubber, vulcanized ethylene propylene copolymer, chlorinated polyethylene, chlorosulfonated polyethylene, polybutadiene rubber, polyolefin elastomers, polyurethane elastomers, butadiene styrene copolymer rubbers, polychloroprene (neoprene) rubber, hydrocarbon rubbers, polyisobutylene, butyl rubber ( a copolymer of isobutylene and isoprene) and polyisoprene (natural) rubbers. It should be understood that excessive vulcanization of natural rubber will produce hard rubber, which is rather brittle and, thus, unsuitable for the present invention. Polyesters which are fomulated for flexibility may be suitable thermosetting plastics. Polyethylenes, vinyls, polypropylenes, polyamides, polycarbonates, and polyurethanes may be suitable thermoplastic compounds.

Still referring to FIG. 1, for a preferred embodiment of the invention, a plurality of eyelets 102A-102E have been embedded in the body 101 during the molding process. Each eyelet 102A, 102B, 102C, 102D or 102E has an aperture that extends from one side of the body to the other.

Referring now to FIG. 2, this cross-sectional view shows the profile of a first specific embodiment shape for the body 101, which is of generally circular cross section from the head 201 to the tail 202. It can be seen that each of the eyelets 102A-102E has a central aperture 203.

Referring now to FIG. 3, this cross-sectional view shows the profile of a second specific embodiment shape for the body 101, which is of generally circular cross section in the head portion 301 and in tail portion 302, as well as in each of the five eyelet regions 303A-303E. Between eyelet regions, this alternate embodiment body 101-B tapers from circular cross section to oval cross section between the eyelets 303, generally. This tapering facilitates bending of the body 101-B between the eyelets 303, generally.

Referring now to FIG. 4, a fishing line 401 has been threaded, first through a first embodiment resistance device 402, then through the aperture 302 of each of the eyelets 102A-102E, beginning with eyelet 102A. IT Will be noted that the direction of insertion into each aperture 302 alternates with each succeeding eyelet 102. After the end of the fishing line is inserted through the eyelet 102E nearest the head 201 of the body 101, it is inserted through a bead 403, and then tied to the eye 404 of a hook 405. The bead 403 prevents the hook 405 from being pulled into the aperture 302 of eyelet 102E, and also spaces the hook 405 away from the body 101. The first embodiment resistance device 402 comprises a disk 406 and a concentric tubular extension 407, which spaces the first embodiment resistance device 402 away from the body 101. For a preferred embodiment of the invention, the first embodiment resistance device 402 is an injection-molded rigid or semi-rigid unitary component. A spherical stop 408 is crimped on the fishing line 401 and prevents the first embodiment resistance device 402 from sliding away from the body 101 on the fishing line 401.

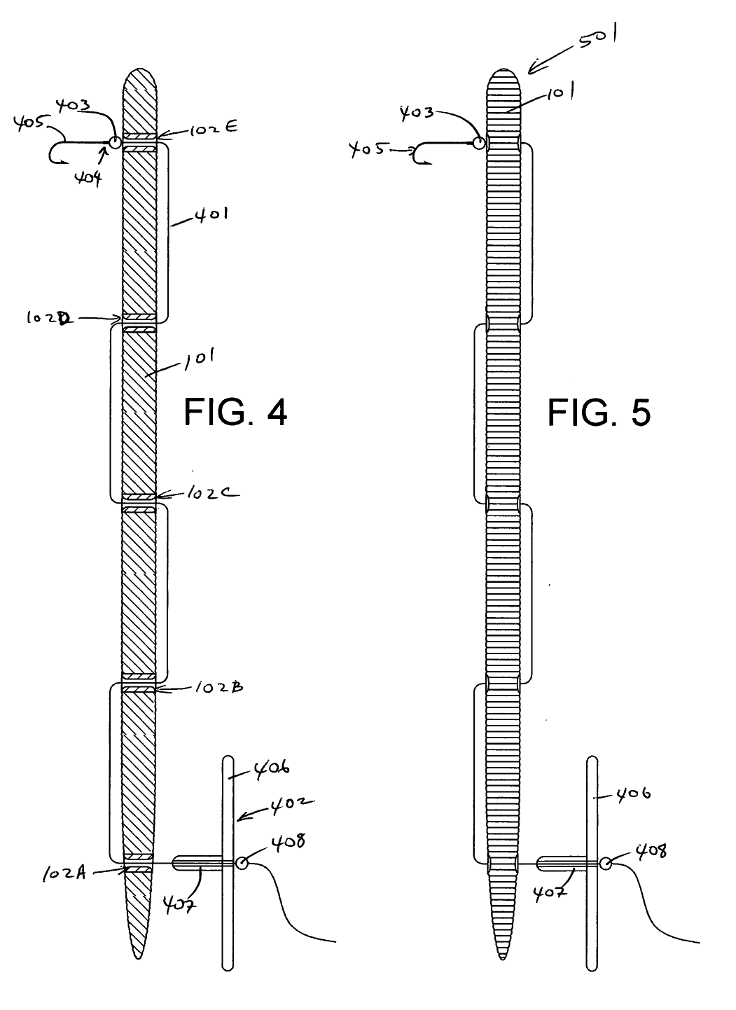

Referring now to FIG. 5, the complete assembly of FIG. 4 is shown as an elevational view. This view represents the completely assembled first general embodiment fishing lure 501. The alternate embodiment lure shown in FIG. 3 is assembled in an identical manner.

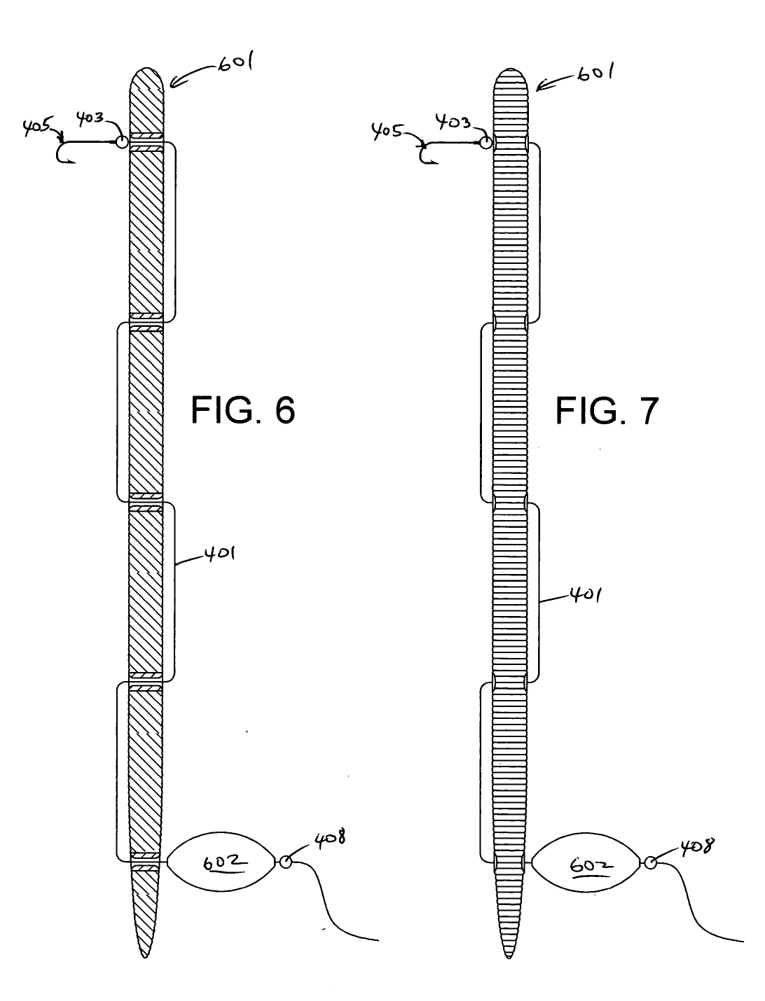

Referring now to FIG. 6, this complete fishing lure assembly 601 is identical to that of FIG. 4, with the exception that the first embodiment resistance device 402 has been replaced with a second embodiment resistance device 602, which is simply a sliding weight made of lead or other high-density metal.

Referring now to FIG. 7, the complete fishing lure assembly 601 of FIG. 6 is shown as an elevational view.

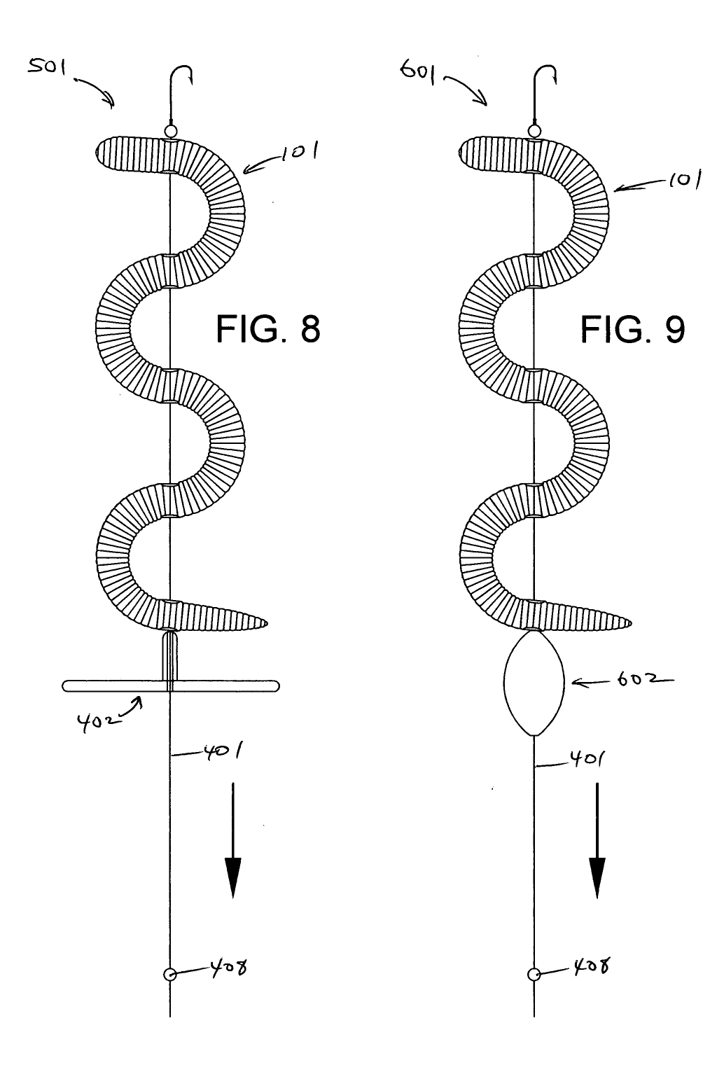

Referring now to FIG. 8, a tug on the fishing line 401 of the complete fishing lure assembly 501 has caused the first embodiment resistance device 402 to slide away from the spherical stop 408 towards the hook 405, applying a force on the resilient worm body 101 that causes it to bend, forming four interconnected semicircular sections 801A-801D. Eyelet 102B is positioned at the junction of semicircular sections 801A and 801B; eyelet 102C is positioned at the junction of semicircular sections 801B and 801C; and eyelet 102D is positioned between semicircular sections 801C and 801D. Eyelet 102A is positioned between the tail 202 and semicircular section 801A, while eyelet 102E is positioned between the head 201 and semicircular section 801D. For this embodiment, the sliding of the first embodiment resistance device 402 toward the hook 405 is caused primarily by its resistance to movement in the water as the entire assembly 501 and the fishing line 401 are moved. Potential energy stored in the distorted elastomeric body 101 will return that body 101 to its original unbent shape when the force applied by the first embodiment resistance device 402 is released.

Referring now to FIG. 9, a tug on the fishing line 401 of the complete fishing lure assembly 601 has produced a similar result as that depicted in FIG. 8. However, for this embodiment, the sliding of the second embodiment resistance device 602 toward the hook 405 is primarily caused by the inertia of the second embodiment resistance device, or slidable weight, 602. Because the slidable weight 602 will rapidly accelerate, the bending of the worm body 101 occurs only for a very short period of time, whereas the bend of the worm body 101 can be sustained for much longer periods using the first embodiment resistance device disk 402.

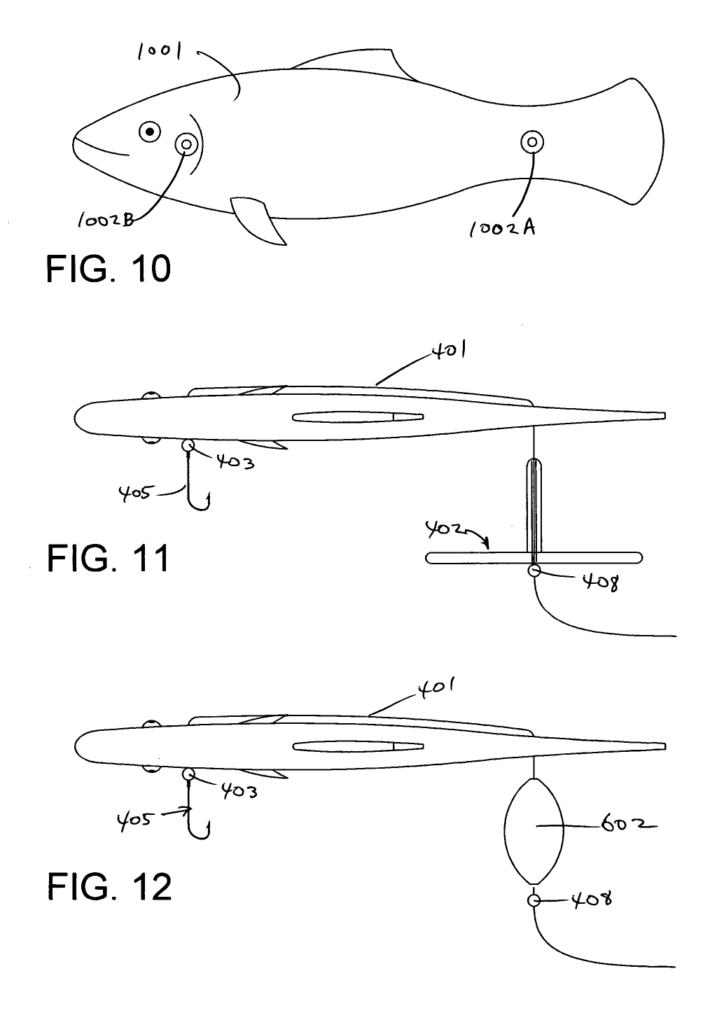

Referring now to FIG. 10, a second general embodiment of the bendable resilient fishing lure has a resilient body 1001 molded in the shape of a small fish, or minnow. The body may be molded from the same types of elastomeric compounds as used to mold the first general embodiment resilient worm body 101. The second embodiment resilient body 1001 has a pair of embedded eyelets 1002A and 1002B that are functionally identical to those used for the first embodiment worm body 101. Each of the two embedded eyelets has a central aperture 1003.

Referring now to FIG. 11, a fishing line 401 has been threaded, first through a first embodiment resistance device 402, then through the left side of eyelet 1002A, then through the right side of eyelet 1002B, through the bead 403, and then, finally, tied to the eye 404 of a hook 405. The bead 403′ prevents the hook 405 from being pulled into the central aperture 1003 of eyelet 1002B, and also spaces the hook 405 away from the body 1001. A spherical stop 408 is crimped on the fishing line 401 and prevents the first embodiment resistance device 402 from sliding away from the body 1001 on the fishing line 401. This view represents a completely assembled second general embodiment fishing lure 1101.

Referring now to FIG. 12, this complete fishing lure assembly 1201 is identical to that of FIG. 11, with the exception that the first embodiment resistance device 402 has been replaced with a second embodiment resistance device sliding weight 602.

Referring now to FIG. 13, a tug on the fishing line 401 of the-complete fishing lure assembly 1101 has caused the second embodiment resistance device 402 to slide away from the spherical stop 408 towards the hook 405, applying a force on the resilient minnow body 1001 that causes it to bend. In this drawing figure, the resilient minnow body 1001 has attained a U-shaped configuration 1301, with eyelets 1002A and 1002B much closer together than when the resilient minnow body 1001 is in the unbent configuration. For this embodiment, the sliding of the first embodiment resistance device 402 toward the hook 405 is caused primarily by its resistance to movement in the water as the entire assembly 1101 and the fishing line 401 are moved. Potential energy stored in the distorted elastomeric minnow body 1001 will return that body 1001 to its original unbent shape when the force applied by the first embodiment resistance device 402 is released.

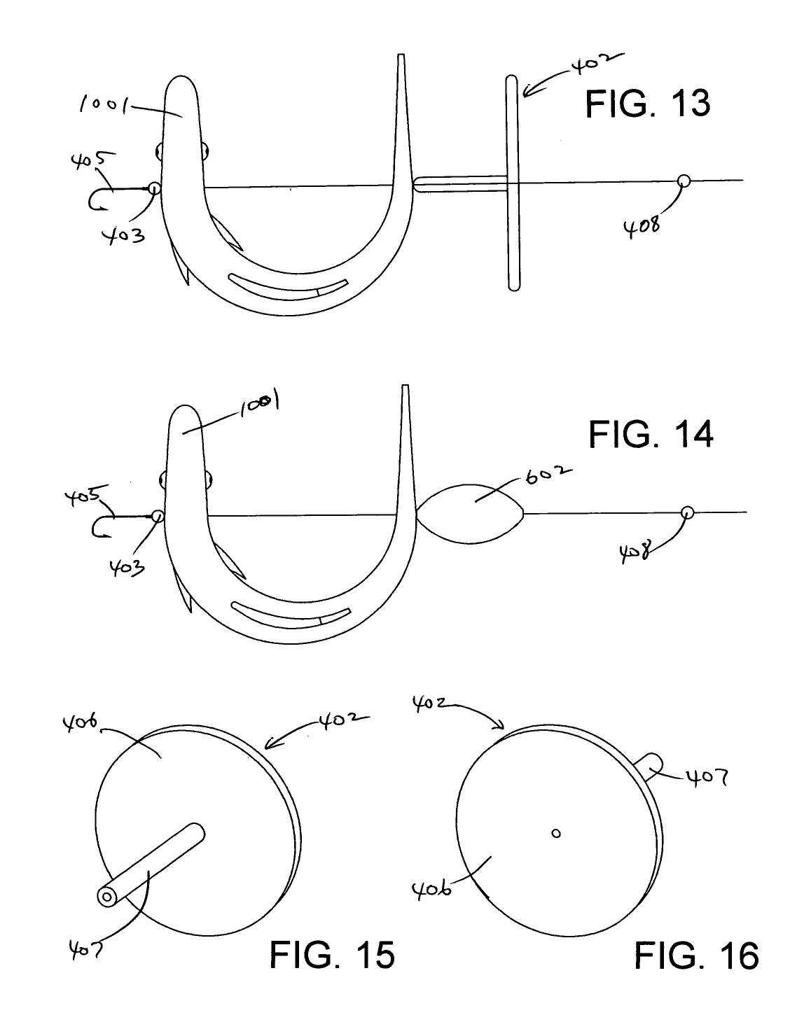

Referring now to FIG. 14, a tug on the fishing line 401 of the complete fishing lure assembly 1201 has produced a similar result as that depicted in FIG. 13. However, for this embodiment, the sliding of the second embodiment resistance device 602 toward the hook 405 is primarily caused by the inertia of the second embodiment resistance device, or slidable weight, 602. Because the slidable weight 602 will rapidly accelerate, the bending of the resilient minnow body 1001 occurs only for a very short period of time, whereas the bend of the minnow body 1001 can be sustained for much longer periods using the first embodiment resistance device disk 402.

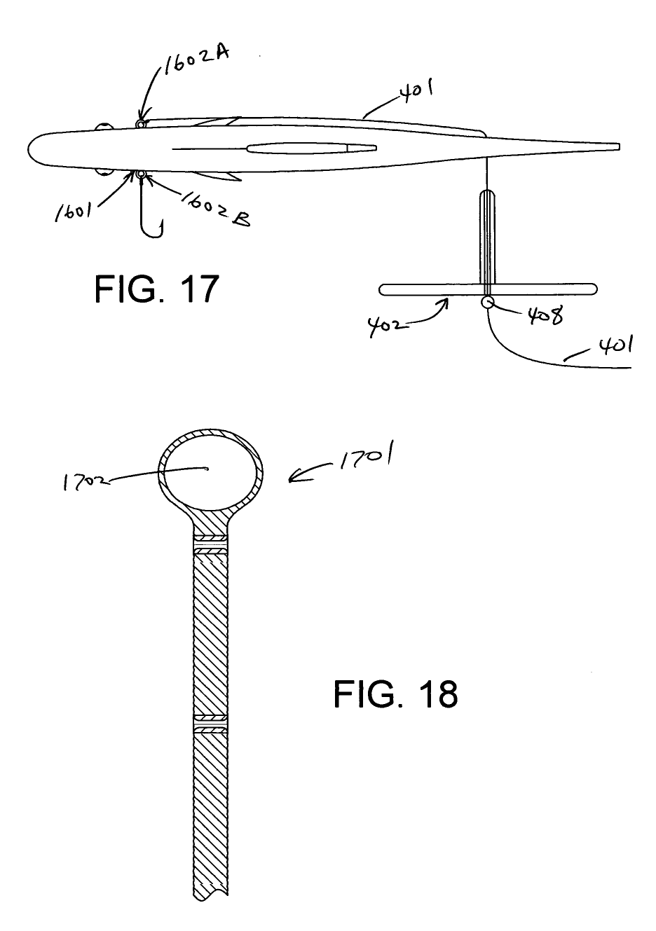

Referring now to FIGS. 15 and 16, the first embodiment resistance device 402 is shown in an isometric view so that the details of the disk portion 406 and tubular extension portion 407 are more readily visible.

Referring now to FIG. 16, an/alternate method of securing the fishing line 401 and hook 405 is shown. An insert is embedded in the worm body 101 in place of eyelet 102E. The insert has loops 1601A and 1601B on right and left sides of the minnow body 1001, respectively. The fishing line 401 is tied to loop 1601A, while the hook 405 is tied to loop 1601B.

Referring now to FIG. 17, an alternate embodiment 1701 of the resilient worm body is shown. This embodiment incorporates a bladder in the head portion of the body that may be sized to balance the weight of the second embodiment resistance device 602.

Although only several embodiments of the invention have been disclosed herein, it will be obvious to those having ordinary skill in the art that changes and modifications may be made thereto without departing from the spirit and scope of the invention as hereinafter claimed.

1. A fishing lure, that simulates the movement of live bait when an attached fishing line is tugged, said fishing lure comprising:
a resilient body molded to appear like a small animal, said resilient body having a fishing line securing device and at least one aperture in the body spaced apart from the anchoring device;
at least one hook attached to said resilient body;
a resistance device; and
a fishing line routed slidably through the resistance device, then through said at least one aperture and then secured to the fishing line securing device;
wherein when the said fishing line is tugged, said resistance device slides and generates a force against said resilient body, causing it to bend and store energy which returns said resilient body to its original shape when the force is released.

2. The fishing lure of claim 1, wherein said resistance device is a disk that is axially perpendicular to said fishing line.

3. The fishing lure of claim 2, wherein said disk has a tubular extension that is coaxial with the disk axis, said tubular extension facing said resilient body.

4. The fishing lure of claim 1, wherein said fishing line securing device comprises an aperture in said resilient body, through which an end of the fishing line is routed and tied to the eye of said hook.

5. The fishing lure of claim 4, wherein said end is routed through a bead before it is tied to said eye, said bead being positioned between said hook and said resilient body.

6. The fishing lure of claim 1, wherein said securing device is a loop embedded in said resilient body, and an end of said fishing line is tied to that loop.

7. The fishing lure of claim 1, wherein said resistance device is a metal weight.

8. The fishing lure of claim 1, which further comprises a stop crimped on said fishing line, which prevents said resistance device from sliding away from said resilient body.

9. The fishing lure of claim 1, wherein said resilient body is in the shape of a small fish.

10. The fishing lure of claim 1, wherein said resilient body is in the shape of a worm.

11. The fishing lure of claim 10, wherein said body has at least four spaced-apart apertures.

12. A fishing lure, that simulates the movement of live bait when an attached fishing line is tugged, said fishing lure comprising:
a body molded from elastomeric material having the shape of a small animal, said body having first and second ends and at least one aperture spaced away from said first end;
at least one hook attached to said body;
a water resistance device having a central tubular opening and a surface that generally planar and perpendicular to said tubular opening; and
a fishing line secured to said body adjacent said first end and passing, in the following order, first through said at least one aperture, and then through the central tubular opening of said water resistance device, with said water resistance device being oriented so that said generally planar surface faces away from said body;
wherein when the said fishing line is tugged, said water resistance device slides and generates a force against said resilient body, causing it to bend and store energy, said stored energy returning said resilient body to its original shape when the force is released.

13. The fishing lure of claim 12, wherein said body is in the shape of a worm.

14. The fishing lure of claim 12, wherein said body is in the shape of a small fish.

15. The fishing lure of claim 12, wherein said water resistance device has a tubular extension that spaces said generally planar surface away from said body, said tubular extension applying said force on said body when said fishing line is tugged.

16. The fishing lure of claim 12, wherein said fishing line is secured adjacent said first end by threading it through a fishing line securing aperture in said body that is positioned adjacent said first end, and securing it to an eye of the hook.

17. The fishing lure of claim 16, wherein said fishing line is routed through a bead before it is tied to said eye, said bead being positioned between said hook and said body.

18. The fishing lure of claim 12, wherein said fishing line is secured adjacent said first end by tying it a loop embedded in said body.

19. The fishing lure of claim 12, which further comprises a stop crimped on said fishing line, which prevents said water resistance device from sliding away from said body.

20. The fishing lure of claim 13, wherein said body has at least four spaced-apart apertures.
